(19) United States
(12) Patent Application Publication
(10) Pub. No.: US 2006/0143301 A1
(43) Pub. Date: Jun. 29, 2006

(54) Systems and methods for establishing and validating secure network sessions

(75) Inventors: Thomas Merkh, Westmont, NJ (US); Anthony Tancredi, Pennsville, NJ (US)

Correspondence Address: Daniel H. Golub, 1701 Market Street, Philadelphia, PA, 19103, US

(73) Assignee: World Extend, LLC, Mount Laurel, NJ (US)

(21) Appl. No.: 11/355,797

(22) Filed: Feb. 16, 2006

Related U.S. Application Data
(62) Division of application No. 11/101,150, filed on Apr. 7, 2005.
(60) Provisional application No. 60/560,680, filed on Apr. 8, 2004.

(51) Int. Cl. G06F 15/16

(52) U.S. Cl. 709/227; 709/228

(57) ABSTRACT

A method and system for establishing a TCP/IP connection between a client and an application server. A request to establish a session is sent from the client to a central server. In response to the request, the central server randomly selects a port in the application server, and a connection request record having a status field and a port field is created in a database at the central server. The status field is set to a first value, and the port field is set to a value corresponding to the randomly selected port. The connection request record has a unique signature known to the application server. The application server monitors the database for new connection request records having a status field set to the first value. Upon detection by the application server of the connection request record, the application server opens the randomly selected port, and sends to the central server, an acknowledgement that the randomly selected port is open. Upon receipt of the acknowledgement at the central server, the central servers sets the status field to a second value. In response to detection by the client that the status field is set to the second value, the client retrieves from the central server the value identifying the randomly selected port, and establishes a TCP/IP connection between the client and the randomly selected port.

### CROSS-REFERENCE TO RELATED APPLICATION

The present application claims priority based on U.S. Provisional Patent Application No. 60/560,680, filed Apr. 8, 2004, entitled “Methods for Establishing and Validating Sessions,” the contents of which are incorporated herein in their entirety by reference.

### FIELD OF THE INVENTION

The present application relates generally to systems and methods for establishing and validating secure network connections.

### BACKGROUND OF THE INVENTION

Computer security is becoming increasingly important. The media is replete with stories of computer hackers breaking into computers, or viruses that attack and destroy information stored on computers. Many tools exist for enhancing computer security. For example, a security protocol known as Secure Sockets Layer (SSL) provides both privacy (e.g., secrecy) and authentication (e.g., confidence that a computer's and/or user's asserted identity is true) in the context of the world wide web. SSL technology is now built into many Internet browsers and web servers. The SSL protocol works by encrypting data passing between computers through use of encryption keys and associated encryption techniques. Despite the existence of SSL, additional solutions are required in order to meet the computer security needs of many organizations. The present invention provides one such solution.

### SUMMARY OF THE INVENTION

The present application is directed to a method and system for establishing a TCP/IP connection between a client and an application server. A request to establish a session is sent from the client to a central server. In response to the request, the central server randomly selects a port from the application server, and a connection request record having a status field and a port field is created in a database at the central server. The status field is set to a first value, and the port field is set to a value corresponding to the randomly selected port. The connection request record has a unique signature known to the application server. The application server monitors the database for new connection request records having a status field set to the first value. Upon detection by the application server of the connection request record, the application server opens the randomly selected port, and sends to the central server, an acknowledgement that the randomly selected port is open. Upon receipt of the acknowledgement at the central server, the central server sets the status field to a second value. In response to detection by the client that the status field is set to the second value, the client retrieves from the central server the value identifying the randomly selected port, and establishes a TCP/IP connection between the client and the randomly selected port.

In accordance with a further aspect, the present invention is directed to a method and system for validating a session between a client and an application server. The application server monitors a database at a central server for new connection request records with a randomly selected port. Upon detection of a new connection request record in the database, the application server opens the randomly selected port, and sends an acknowledgement that the randomly selected port is open to the central server. Upon receipt of the acknowledgement, the central server sets a status field in the connection request record to a value that indicates receipt of the acknowledgement by the central server. In response to detection by the client that the status field was set by the central server to indicate receipt of the acknowledgement by the central server, the client retrieves the value identifying the randomly selected port, and establishes a session between the client and the randomly selected port. Next, the application server monitors the status field of the connection request record in order to detect receipt by the central server of a validation signal from the client. The session is terminated by the application server if the application server fails to confirm receipt of the validation signal at the central server within a predetermined period of time following transmission by the application server to the central server of the acknowledgement that the randomly selected port was open.

### BRIEF DESCRIPTION OF THE DRAWINGS

FIG. 1 is a diagram illustrating a method for establishing a TCP/IP connection in accordance with the present invention.

### DETAILED DESCRIPTION OF THE PREFERRED EMBODIMENT

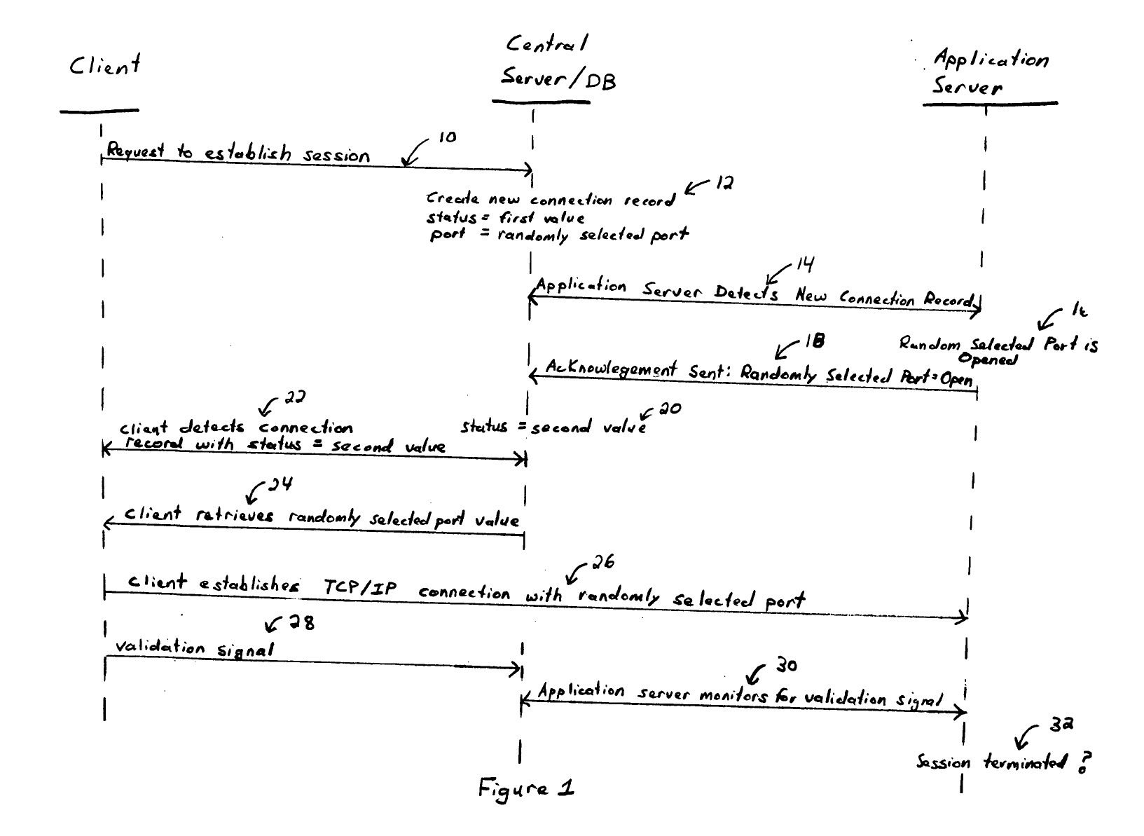

Referring now to FIG. 1, there is shown a diagram illustrating a method for establishing a TCP/IP connection between a client computer (e.g., a workstation or personal computer) and an application server over a computer network such as the internet, in accordance with the present invention. In step 10, the client sends a request to the central server to establish the session. In step 12, and in response to the request, the central server randomly selects a port from the application server (e.g., if the application server includes ports in a range of 9000-9050, an available port within this range is randomly selected), and a connection request record having a status field and a port field is created in a database at the central server. The status field is set to a first value, and the port field is set to a value corresponding to the randomly selected port. The connection request record has a unique signature known to the application server.

The application server continuously monitors the database (step 14) for new connection request records having a status field set to the first value. In step 16, upon detection by the application server of the connection request record (i.e., the application server detects a connection request record having a status field set to the first value in the database), the application server opens the randomly selected port. Next, in step 18, the application server sends an acknowledgement to the central server, that the randomly selected port is open. In step 20, upon receipt of the acknowledgement at the central server, the central servers sets the status field of the connection record to a second value.

In response to detection by the client that the status field is set to the second value (step 22), the client retrieves from the central server the value identifying the randomly selected port (step 24). The client then uses the randomly selected port value in step 26 to establish a TCP/IP connection between the client and the randomly selected port at the application server. After the session is successfully established, the client sends a validation signal to the central server in step 28; the central server then updates the status field of the connection record to reflect receipt of the validation signal from the client (e.g., the central server updates the value of the status field to a third value (different from the first and second values) that reflects receipt of the validation signal from the client.)

In step 30, the application server monitors the status field of the connection request record in order to detect receipt by the central server of a validation signal from the client. The application server terminates the session in step 32 if the application server fails to confirm receipt of the validation signal at the central server within a predetermined period of time following transmission by the application server to the central server of the acknowledgement that the randomly selected port was open (i.e., a predetermined time following step 18).

In one embodiment, the present invention is implemented by separate software that resides on each of the central server, the application server and the client. Among other functions, the software resident at the central server (the central server software) manages the database connection records (described above) and provides functionality that allows software on the application server (the agent software) and the client (the client software) to extract request records from the central server database. In one embodiment, the agent software runs on the application server as a Microsoft Windows Service. In addition to performing step 14 (detection of new connection record), step 18 (acknowledgement that port is open), step 30 (validation signal monitoring) and step 32 (session termination), the agent software includes functionality for defining various configuration values used by the system. The client software includes functionality for performing step 10 (issuing a request to establish a session), step 22 (detection of connection record with status=second value), step 24 (retrieving the randomly selected port value), step 26 (establishing the session with the randomly selected port) and step 28 (sending the validation signal to the central server).

In one embodiment, the present invention is built upon the Microsoft .NET framework, which provides many of the internal interfaces for facilitating the infrastructure of the present invention including: SQL Server for database storage, .NET WEB Services for component communications, ADSI for authentication queries and .NET Cyprtographic Services for encryption.

In one embodiment, the database at the central server stores configuration records for the agent software that resides on each application server in the system, and acts as a centralized request queue for functions performed by the system. In this embodiment, all requests to extract information from the database at the central server are made through the central server software, and all calls to the central server and all data passed between the central server and the application server or client are encryted in accordance with the SSL protocol.

As mentioned above, the status field of each connection record is used for communicating status information to both the application server and the client during the process of establishing a session. In one embodiment, the status field of each connection record is set to a value of 1 in step 12 when the central server first creates a new connection record in response to a client request to establish a connection; the status field of the connection record is set to a value of 2 in step 20 following receipt of the acknowledgement from the application server that the randomly selected port is open; and the status value of the connection record is set to a value of 3 in response to receipt of a validation signal from the client in step 28. It will be understood by those skilled in the art that other values of the status field may be used for communicating the various stages of the connection request, and such other values are considered to be within the scope of the present invention.

As a result of the inventive sequence for establishing a session described in FIG. 1, the present invention is able to maintain the outside TCP/IP ports of the application server closed until the time that they are required. When a connection is requested, the system then performs the series of validation steps described above to ensure that the connection is opened and managed securely. If the validation steps fail to occur in the proper sequence, or in a specified period of time, the connection is automatically terminated.

Finally, it will be appreciated by those skilled in the art that changes could be made to the embodiments described above without departing from the broad inventive concept thereof. It is understood, therefore, that this invention is not limited to the particular embodiments disclosed, but is intended to cover modifications within the spirit and scope of the present invention as defined in the appended claims.

1. A method for establishing a TCP/IP connection between a client and an application server, comprising:
(a) sending a request to establish a session from the client to a central server;
(b) in response to the request, randomly selecting a port at the application server, creating a connection request record having a status field and a port field in a database at the central server, setting the status field to a first value, and setting the port field to a value corresponding to the randomly selected port, wherein the connection request record has a unique signature known to the application server;
(c) monitoring the database for new connection request records having a status field set to the first value, wherein the monitoring is performed by the application server;
(d) upon detection of the connection request record created in step (b), opening the randomly selected port, and sending, from the application server to the central server, an acknowledgement that the randomly selected port is open;
(e) upon receipt of the acknowledgement at the central server, setting the status field to a second value; and
(f) in response to detection by the client that the status field is set to the second value, establishing by the client a TCP/IP connection between the client and the randomly selected port.

2. A system for establishing a TCP/IP connection between a client and an application server, comprising:
(a) a client that sends a request to establish a session from the client to a central server;
(b) a central server that, in response to the request, randomly selects a port at the application server, creates a connection request record having a status field and a port field in a database coupled to the central server, sets the status field to a first value, and sets the port field to a value corresponding to the randomly selected port; and
(c) an application server that monitors the database for new connection request records having a status field set to the first value, wherein the connection request record has a unique signature known to the application server; and wherein upon detection of the connection request record, the application server opens the randomly selected port and sends to the central server an acknowledgement that the randomly selected port is open;
wherein, upon receipt of the acknowledgement at the central server, the central server sets the status field to a second value; and
wherein, in response to detection by the client that the status field is set to the second value, the client establishes a TCP/IP connection between the client and the randomly selected port.

3-4. (canceled)
